(19) United States
(12) Patent Application Publication
(10) Pub. No.: US 2015/0366245 A1
(43) Pub. Date: Dec. 24, 2015

(54) MALT EXTRACT

(71) Applicant: DÖHLER GMBH, Darmstadt (DE)

(72) Inventor: Gerrit Dirk Johannes VAN EGEREN, Venlo (NL)

(21) Appl. No.: 14/766,056

(22) PCT Filed: Feb. 5, 2014
(86) PCT No.: PCT/EP2014/052208

§ 371 Date: Aug. 5, 2015

(30) Foreign Application Priority Data
Feb. 6, 2013 (EP) 13154252.4
Aug. 22, 2013 (EP) 13181398.2

(51) Int. Cl. A23L 1/186; C12C 1/18

(52) U.S. Cl. CPC A23L 1/186; C12C 1/18; A23V 2002/00

(57) ABSTRACT

The invention relates to a method for producing a malt extract, comprising the following steps: a) providing a malt extract, b) treating the malt extract with amyloglucosidase in order to obtain a malt extract hydrolysate, c) treating the malt extract hydrolysate with glucose isomerase in order to obtain an isomerized malt extract hydrolysate, d) adding non-hydrolyzed malt extract, wherein the ratio of non-hydrolyzed malt extract to isomerized malt extract hydrolysate is in the range of 1:20 to 1:1, with respect to the dry substance portion, in order to obtain a partially hydrolyzed malt extract, e) at least partially removing water to a dry substance content of more than 68 wt %.

The present invention relates to a process for preparing a malt extract, and to the malt extract obtainable by the process according to the invention.

Malt extracts are syrups produced from cereals. Thus, cereals are soaked in water in a known way, and made to germinate (malting). The malt thus obtained is comminuted (crushed) in a malt mill, followed by mashing. During the mashing, the temperature is adjusted to have starch degraded by enzymatic activity from the cereals, especially by amylase. Also, the existing proteins are degraded into amino acids during the mashing. Subsequently, the mash is filtered (lautering), and the filtrate obtained is mostly brought to the boil. The malt extract thus obtained is also referred to as wort and has a high content of maltose and some proportion of longer sugars (chain lengths of 3 or more).

Such malt extracts typically have about the following carbohydrate composition:
8% by weight glucose;
52% by weight maltose;
12% by weight sugars having a chain length of 3;
24% by weight sugars having a chain length of more than 3, based on the total content of sugar.

“Sugars having a chain length of 3” means that the sugar includes three monomer units, typically hexoses. Accordingly, “sugars having a chain length of more than 3” means that the sugar includes four or more linked monomer units, especially hexoses.

The thus obtained malt extracts have a pleasant malty and sweet taste and are employed for various purposes, for example, in the production of bakery, as starting materials for beer production, as a component of malt beverages, as a carbohydrate source, or generally as a functional ingredient in the food industry. A great disadvantage of the thus obtained malt extract is the fact that it either has a relatively high water content, and is microbiologically very sensitive then, however, or, if it has a lower water content, has a high viscosity, which brings about a poor processability. Thus, for example, mixing processes or transport by pumping and generally the handling as a liquid are highly affected.

Therefore, there is a need for forms of malt extracts that are characterized by an improved keeping quality and improved processability.

The object of the present invention is to provide such extracts and a process for producing them.

This object is achieved by a process for preparing a malt extract, comprising the steps:
a) providing a malt extract;
b) treating it with amyloglucosidase to obtain a malt extract hydrolysate;
c) treating it with glucose isomerase to obtain an isomerized malt extract hydrolysate;
d) adding non-hydrolyzed malt extract, the ratio of non-hydrolyzed malt extract to isomerized malt extract hydrolysate being from 1:20 to 1:1, based on the dry matter content, to obtain a partially hydrolyzed malt extract;
e) at least partially removing water up to a dry matter content of more than 68% by weight.

Thus, according to the invention, a malt extract is provided in the first step. The preparation of malt extracts is known to the skilled person. These are formed by soaking cereals until they germinate, followed by comminuting and enzymatic degradation of starch into lower molecular weight carbohydrates, followed by filtration and a heating step to inactivate the enzymes.

Variants of the process are known to the skilled person. These are always processes in which the existing starch from cereals is converted to short-chained carbohydrates by means of enzymatic processes. A wide variety of starch-containing products can be employed as the starting material, especially barley, wheat, rye, spelt, corn, rice, spelt, kamut, sorghum, or mixtures thereof.

In the next step, amyloglucosidase is added. This is an amylase that can cleave off glucose units from the chain end of larger molecules (EC 3.2.1.3). For the treatment with amyloglucosidase, the pH of the malt extract is adjusted, if necessary, to a suitable pH range, for example, from 3.5 to 6. Temperatures of from 50 to 70° C. for 24 to 96 hours have been found to be suitable temperatures and times.

In some embodiments of the invention, it may be reasonable to additionally add pullulanase (EC 3.2.1.41). This enzyme is capable of hydrolyzing amylopectin, for example.

While it is the object to convert the major part of the existing sugars to glucose in some embodiments, the amyloglucosidase treatment is at least performed until at least 20% by weight of glucose are present in the hydrolyzed extract, based on the carbohydrates (dry matter). Preferably, however, the content of glucose is at least 50% by weight, more preferably at least 70% by weight, even more preferably at least 90% by weight.

This is followed by a treatment with a glucose isomerase, an enzyme that catalyzes the conversion of glucose to fructose. Since some forms of glucose isomerase (EC 5.3.1.5) have their optimum at higher pH values than that of amyloglucosidase, it may be reasonable to adjust the pH accordingly, for example, to a pH range of from 7 to 8.5. The temperature range of from 45 to 70° C. has proven useful as the temperature for the treatment with glucose isomerase.

In some embodiments, the treatment is effected while the glucose isomerase is employed in an immobilized form, i.e., bonded to a solid phase. In such a case, it is possible both to perform the treatment within a column through which the hydrolyzed malt extract is pumped, and to perform batch treatments in which immobilized glucose isomerase is added to a larger quantity of a hydrolyzed malt extract.

In both enzymatic reactions, it is reasonable to adapt to the specific conditions of the enzymes, for example, with respect to the ion concentrations, cofactors, pH values etc. that are necessary for the activity.

Both amyloglucosidase and glucose isomerase are commercially available, and optimized conditions of use are usually mentioned in the product descriptions.

Preferably, the treatment with glucose isomerase is effected until at least 30% by weight fructose has formed, based on the carbohydrates (dry matter).

In some embodiments, it may be reasonable to perform further steps between the treatment with amyloglucosidase and the treatment with glucose isomerase, for example, an ion exchange treatment in order to remove ions necessary for one enzyme before the next enzymatic treatment if they have a disturbing effect therein.

Next, the mixing of the isomerized malt extract hydrolysate with a non-hydrolyzed malt extract, i.e., an untreated malt extract, is effected. In principle, the non-hydrolyzed malt extract may originate from the same preparation, but it may also originate from another malt extract preparation. The addition prevents undesirable crystallization, among other things.

The ratio of non-hydrolyzed malt extract to isomerized malt extract hydrolysate is within a range of from 1:20 to 1:1, preferably within a range of from 1:10 to 1:2, weight parts, based on the dry weight. The mixing yields a product that contains larger amounts of glucose and fructose as compared to untreated malt extract.

In the next step, a partial, at first, removal of water from the preparation is effected. The dry matter content should be more than 68% by weight. Preferably, the removal of water is continued until a specific predefined AW value is reached.

The AW value is the water activity, a measure for the free available water in a material. It is defined as the quotient of the water vapor pressure above a material (p) and the water vapor pressure above pure water (p₀) at a particular temperature: AW=p/p₀. The measuring temperature according to ISO is 25° C.

This determines the possibility of the growing of microorganisms and thus the keeping quality of foods. The lower the AW value, the more difficult it is for microorganisms to grow, and the higher is the keeping quality of the product.

According to the invention, the water should be removed until the AW value is <0.84, and preferably AW≦0.74. Thus, the extract according to the invention is microbiologically stable. Nevertheless, because of its specific composition, it has a viscosity that typically does not exceed 3000 mPa·s at 20° C. (as measured according to DIN 53019), especially 500 to 1000 mPa·s.

Therefore, the partially hydrolyzed malt extract obtained has typical malt properties with respect to its properties and applicability, but has a substantially lower viscosity, so that it can be simply pumped, for example. Crystallization of the sugars contained is reliably avoided.

In other words, a malt extract that combines a high microbiological stability with a low viscosity is obtained.

The invention also relates to a partially hydrolyzed malt extract having
a viscosity of from 300 to 3000 mPa·s at 20° C. according to DIN 53019;
a composition of the sugar of
   from 22 to 42% by weight fructose;
   from 32 to 52% by weight glucose;
   from 4 to 26% by weight maltose;
   <12% by weight sugars having a chain length of 3;
   <10% by weight sugars having a chain length of more than 3.

Preferably, the AW value of this malt extract according to the invention is <0.80, more preferably ≦0.74.

The invention also relates to a partially hydrolyzed malt extract obtainable by the process according to the invention.

The invention will be illustrated by the following Examples.

### EXAMPLE 1

### Production of Malt Extracts

### Malt Extract I

Barley malt was crushed with a hammermill. The crushed malt was mashed by adding hot water. After mashing, the malt was lautered (filtered off) to obtain a wort from which the solids had been separated. The wort was concentrated to a barley malt extract. It had 17.5% by weight dry matter content and the following sugar composition:
8% by weight glucose;
52.0% by weight maltose;
12.0% by weight sugars having a chain length of 3;
24.0% by weight sugars having a chain length of more than 3.

### Malt Extract II

Wheat was crushed with a hammermill. The crushed malt was mashed by adding hot water. After mashing, the malt was lautered (filtered off) to obtain a wort from which the solids had been separated. The wort was concentrated to a wheat malt extract. This extract had 21% by weight dry matter content and the following sugar composition:
12.6% by weight glucose;
48.9% by weight maltose;
21.2% by weight sugars having a chain length of 3;
17.2% by weight sugars having a chain length of more than 3.

The extracts were further processed separately and in parallel.

### EXAMPLE 2

Treatment with Amyloglucosidase

The malt extracts from Example 1 were divided. They were adjusted to a pH of 4.3 and admixed with 0.6 g of amyloglucosidase/kg of starch. The temperature was set to 61° C.+/−1° C., and the treatment was effected for 72 hours. The analysis of the sugar composition yielded the result that the content of glucose was more than 90% by weight of the sugar composition.

### EXAMPLE 3

Treatment with Glucose Isomerase

The pH of the hydrolyzed malt extracts was adjusted to 7.5 using Na₂CO₃. In addition, 1 g/L MgSO₄ and 0.18 g/L NaS₂O₅ were added. The solution having a temperature of about 55 to 60° C. was degassed. Immobilized glucose isomerase with a loading of 400 U/g was filled into a column, and the solution obtained from Example 2 was pumped through the column. The flow rate was adjusted so that from 5 to 6 kg of hydrolyzed malt extract per kg of immobilized solid phase per hour passed through the column. The malt extract hydrolysate was pumped in circuit until the fructose content, based on the dry carbohydrate content, was 42% by weight. Since the conversion rate decreases as the fructose concentration increases, a chemical equilibrium is reached.

This was followed by a treatment with active charcoal previously activated with steam.

### EXAMPLE 4

### Mixing

The isomerized malt hydrolysates obtained were admixed with the untreated malt extracts from Example 1.

### Malt Extract I

21.2 weight parts of the non-hydrolyzed malt extract was admixed with
78.8 weight parts of the isomerized hydrolyzed malt extract. The mixture obtained had the following sugar composition:
glucose: 44.9% by weight;
fructose: 33.6% by weight;
maltose: 12.1% by weight;
sugars having a chain length of 3 and sugars having a chain length of more than 3: 9.2% by weight.

The dry matter content of the solution was 71% by weight, the sweetening power of the product was comparable with that of a corresponding solution of sucrose.

### Malt Extract II

The isomerized malt hydrolysate obtained was admixed with the untreated malt extracts from Example 1. 7.5 weight parts of the non-hydrolyzed malt extract was admixed with 92.5 weight parts of the isomerized hydrolyzed malt extract. The mixture obtained had the following sugar composition:
glucose: 44.4% by weight;
fructose: 34.2% by weight;
maltose: 12.9% by weight;
sugars having a chain length of 3 and sugars having a chain length of more than 3: 8.5% by weight.

The dry matter content of the solution was 71% by weight, the sweetening power of the product was comparable with that of a corresponding solution of sucrose.

### EXAMPLE 5

### Viscosity

While a malt extract with 80° Brix had a viscosity of 45,000 mPa·s at 20° C., the partially hydrolyzed malt extract I after mixing had a viscosity of 740 mPa·s; the partially hydrolyzed malt extract II had a viscosity of 600 mPa·s.

1. A process for preparing a malt extract, comprising the steps:
a) providing a malt extract;
b) treating the malt extract with amyloglucosidase to obtain a malt extract hydrolysate;
c) treating the malt extract hydrolysate with glucose isomerase to obtain an isomerized malt extract hydrolysate;
d) adding non-hydrolyzed malt extract, the ratio of non-hydrolyzed malt extract to isomerized malt extract hydrolysate being from 1:20 to 1:1, based on dry matter content, to obtain a partially hydrolyzed malt extract;
e) at least partially removing water up to a dry matter content of more than 68% by weight.

2. The process according to claim 1, wherein said malt extract is obtained from barley, wheat, rye, kamut or mixtures thereof, optionally with the addition of unmashed cereals and pseudocereals, such as corn, rice, spelt.

3. The process according to claim 1, wherein said treatment with amyloglucosidase is performed at a temperature of from 50 to 70° C. for 2 to 96 hours.

4. The process according to claim 1, wherein characterized in that said treatment with amyloglucosidase is performed until at least 20% by weight of glucose has formed, based on dry matter of the carbohydrates.

5. The process according to claim 1, wherein said glucose isomerase has been immobilized.

6. The process according to claim 5, wherein said treatment with glucose isomerase is performed in a column or as a batch treatment.

7. The process according to claim 1, wherein an ion exchange treatment is performed between the treatment with amyloglucosidase and the treatment with glucose isomerase.

8. The process according to claim 1, wherein the ratio of non-hydrolyzed malt extract to isomerized malt extract hydrolysate is within a range of from 1:10 to 1:2.

9. The process according to claim 1, wherein water is removed until the AW value is <0.80.

10. The process according to claim 1, wherein water is removed until the viscosity according to DIN 53019 does not exceed 3000 mPa·s at 20° C.

11. A partially hydrolyzed malt extract having
a viscosity of from 300 to 1500 mPa·s;
a composition of the sugar of
from 22 to 42% by weight fructose;
from 32 to 52% by weight glucose;
from 4 to 26% by weight maltose;
<12% by weight sugars having a chain length of 3;
<10% by weight sugars having a chain length of more than 3.

12. The partially hydrolyzed malt extract according to claim 11, said AW value is 0.74.

13. A partially hydrolyzed malt extract obtained by the process according to claim 1.

14. The process, according to claim 1, wherein water is removed until the AW value is ≦0.74.
